(19) United States
(12) Patent Application Publication
(10) Pub. No.: US 2024/0152429 A1
(43) Pub. Date: May 9, 2024

(54) Recoverable Processes

(71) Applicant: Microsoft Technology Licensing, LLC, Redmond, WA (US)

(72) Inventors: Jonathan D. GOLDSTEIN, Woodinville, WA (US); Philip A. BERNSTEIN, Bellevue, WA (US); Soujanya PONNAPALLI, Austin, TX (US); Jose M. FALEIRO, Redmond, WA (US); Peter Charles SHROSBREE, Redmond, WA (US)

(73) Assignee: Microsoft Technology Licensing, LLC, Redmond, WA (US)

(21) Appl. No.: 17/981,296

(22) Filed: Nov. 4, 2022

(51) Int. Cl. G06F 11/14; G06F 11/07

(52) U.S. Cl. CPC G06F 11/1435; G06F 11/0793; G06F 11/1471

(57) ABSTRACT

The description relates to enhancing computer performance, such as by decreasing latency associated with storage operations. One example can include recoverable processes. Each recoverable process can be configured to periodically write log records to individual storage partitions. Each log record includes a vector timestamp that describes the processes' dependencies on log records of other recoverable processes.

### BACKGROUND

Computer users demand both continually enhanced performance and high data integrity. However, these tend to be competing interests where ensuring data integrity slows the performance aspect.

### BRIEF DESCRIPTION OF THE DRAWINGS

The accompanying drawings illustrate implementations of the concepts conveyed in the present patent. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIGS. 1 and 8 show example systems in which the present concepts can be applied in some implementations.

FIG. 2 shows example components that are consistent with some implementations of the present concepts.

FIG. 3 shows an example recovery log that is consistent with some implementations of the present concepts.

FIGS. 4-6 show example speculative recoverable methods relative to specific actors for accomplishing the present concepts in accordance with some implementations.

FIG. 7 shows an example flowchart for accomplishing the present concepts in accordance with some implementations.

### DETAILED DESCRIPTION

This patent relates to data integrity and maintaining data integrity without slowing down other computing aspects. Briefly, many processes occurring on computers include accessing and writing data to storage and recording or logging these activities. Traditionally, these aspects are treated in a serial fashion in that the process is not allowed to move forward until the activities are both logged and performed. However, the logging may occur much faster than the storing and thus storing is often a limiting factor from a time perspective.

Further, traditionally these processes are siloed so that other processes cannot access the data until it is both logged and safely (e.g., persistently) stored. However, in reality many processes tend to be running simultaneously. These processes are often interrelated with one process needing data from another process to move forward. However, the traditional siloed nature creates a bottleneck that slows down this access until the data is safely stored. The present concepts solve this bottleneck by speculating that the data storage will in fact occur and logging the activity before it is actually persistent. The present concepts allow the process to move forward and rely on the log based on this speculative presumption that the persistent storage will subsequently occur. The present concepts also allow other processes that rely on the stored data to rely on the log so that they are not delayed. Thus, the present concepts reduce or eliminate delay within a process and between processes to greatly decrease delay associated with waiting for the persistent storage to occur. The present concepts enable this speculative approach by ensuring that a clear representation of the activities, storage, and interrelationships are maintained so that in instances where the persistent storage does not subsequently occur that the process and/or processes can fall back to a state which does not rely on any of the speculation so that no data is lost.

The aspects introduced above are now explained in more detail, starting with a description of traditional logging and storage techniques. For purposes of explanation a cloud-based scenario is now described, but the present concepts apply to various computing scenarios including processes on a self-contained device, such as a smartphone or notebook computer. In the cloud, many applications are composed of networks of communicating applications, each of which stores information in replicated storage for the purposes of recovering in the event of a failure (e.g., power, hardware, software environment). This storage frequently takes the form of a log, which consists of a sequence of records, each of which represents a point in the local computation which the application may recover to. These applications typically implement their own log on top of durable storage (e.g., transactional databases), or use some cloud log storage service, in conjunction with a complex mix of their own and cloud service-based deployment and recovery infrastructure. Writing and deploying such applications is complex and error prone, forcing application writers to make complex decisions around issues like consistency, durability, recoverability, and high availability, resulting in high system complexity around aspects that are not core to their value proposition.

Orthogonally, these applications typically choose to only communicate results to other parties after the associated log records have been durably stored, ensuring that other parties only act upon fully recoverable information, simplifying recovery in the event of failure. This choice has become particularly burdensome because the latency to store a log record in replicated cloud storage is at least in the millisecond range, while network communication can be as little as a microsecond. If forward progress in the application depends upon network communication, and applications perform a write operation and wait for it to complete prior to sending messages, progress is therefore slowed by as much as three orders of magnitude. (As used herein, the terms ‘write operation’ and ‘writes’ can be used interchangeably).

A popular approach for developing recoverable applications employs distributed transactions, which rely on a distributed protocol called two-phase commit. The two-phase commit is a distributed protocol typically used to implement distributed transactions in a distributed database system, or to implement distributed transactions across database systems.

Generally, in this type of durable storage application clients read the latest committed values as of their read requests processing time. Distributed transactions either commit or abort atomically. In the event of multiple concurrent distributed transactions, the results of these transactions are serializable logically executing transactions in a specific sequential order.

In the event of a failure, all participating database partitions always recover to an internally consistent state, and a state consistent with respect to external clients (e.g., no externally visible lost transactions).

Consider a scenario where an application client submits a distributed, cross-partition transaction to the database. This transaction is atomically committed or aborted in the presence and absence of failures. The database partitions that host the read and write sets of the distributed transaction and the client-chosen database partition that acts as the transaction coordinator are the participants of the protocol. Note that in the description below, the client is considered as an external agent and client failures are not described. Instead, the focus is on failures only during the two phases of the protocol. For example, clients can fail while reading or partitions could fail during the reads, and such failures are out of scope for this description. The two phases of the protocol are now described in scenarios where (a) there are no failures, or (b) if the transaction coordinator fails, or (c) if any database partition fails, in either the first or the second phases of the protocol.

The first discussion point is when the client first fetches the data for the read set of the transaction from the participating partitions and computes and buffers the write set of the transaction. On receiving read requests, database partitions acquire read locks and return the latest committed values for the requested keys to the client. The client then chooses a transaction coordinator for this transaction and initiates the first phase of the protocol by sending a ‘PREPARE’ message to all participants. Along with the PREPARE message, the client sends the transaction, buffered writes, and the transaction coordinator's identity to all participants. Note that the transaction coordinator can sometimes assume the role of a participating database partition if it hosts the transaction's read or write set alongside coordinating the transaction.

In the first phase, on receiving a PREPARE message, the database partitions prepare for the transaction by acquiring the necessary write locks required to commit the transaction. If the partitions can successfully acquire the write locks and persist the transaction's writes at that partition, then they vote YES and otherwise vote NO. Once the decision has been made, they log a transaction PREPARE record and send their votes to the transaction coordinator. The transaction coordinator waits to receive votes from all the participants during the first phase. Once the transaction coordinator receives all of the votes it initializes the second phase of the protocol.

In the second phase, the transaction coordinator decides to commit the transaction if it receives YES votes from all the participants. To commit the transaction, first the transaction coordinator logs a COMMIT record, then it sends a COMMIT message to all the participating database partitions. In response to the COMMIT message, database partitions write values with newer version numbers for the updated keys, and then they log a COMMIT record. Once successful, the database partitions release all the acquired write locks. Note that all parties follow two-phase locking. Note that the lock states are also logged as part of the PREPARE or COMMIT records at the database partitions. The transaction coordinator sends a COMMIT message back to the client when the local COMMIT record is made durable (using the COMMIT record's LSN).

In the first phase, the transaction coordinator waits to receive votes from the participants as a response to the PREPARE message. Note that the database participants sometimes may not be able to hold the necessary write locks in the first phase and hence vote NO. Further, in the event of a partition failure, the transaction coordinator also might not hear back from all the participants. To avoid waiting forever, the transaction coordinator times out after waiting for votes for a certain period. In both of these cases, where the transaction coordinator either receives a single NO vote from the participants or times out during the first phase, the transaction coordinator decides to abort the transaction.

To abort a transaction, the transaction coordinator first logs an ABORT record and sends the ABORT message to all the participants and releases the locks it holds. On receiving the ABORT message, the database partitions also log an ABORT record for the transaction and release their locks. The transaction coordinator sends an ABORT message back to the client when the local ABORT record is made durable (using the ABORT record's LSN). The two-phase commit protocol allows for consistent recovery in the event of failures. The recovery path of the protocol includes logic for coordinator and partition failures.

If the transaction coordinator fails before receiving the client's prepare message, the client retries sending the PREPARE message. Once the transaction coordinator fails over or recovers, it receives the PREPARE message from the client, it requests for votes from the participants, waits for their votes, and proceeds to the second phase as described previously.

If the transaction coordinator receives all the votes, decides to commit the transaction, but fails before logging a commit record, the transaction coordinator after recovering from the failure, requests the participants' votes and decides to commit the transaction. However, if the transaction coordinator fails after writing a commit record, and before it sends a COMMIT message to all its participants, then the transaction coordinator recovers from the failure assuming that the transaction committed successfully, while the participants are waiting to hear back from the transaction coordinator of its decision to either commit or abort this transaction.

In this scenario, the participants request the transaction's decision or result from the transaction coordinator and receive a COMMIT message in response. Once they receive a COMMIT message, they proceed with the second phase of the protocol as described previously.

If the database partitions fail during the PREPARE phase, and if the transaction coordinator times out before the partition failover completes, then the transaction coordinator aborts the transaction. However, if the partition fails during the second phase and misses the COMMIT message from the transaction coordinator, then it requests the transaction result from the transaction coordinator after its failover or recovery are successful. Upon receiving a COMMIT decision or result for this transaction, this partition also logs the transaction COMMIT record, and persists new values with updated version numbers. When the COMMIT record is made durable, the transaction coordinator notifies the client of the transaction commit. The description now focuses on implementing the present concepts.

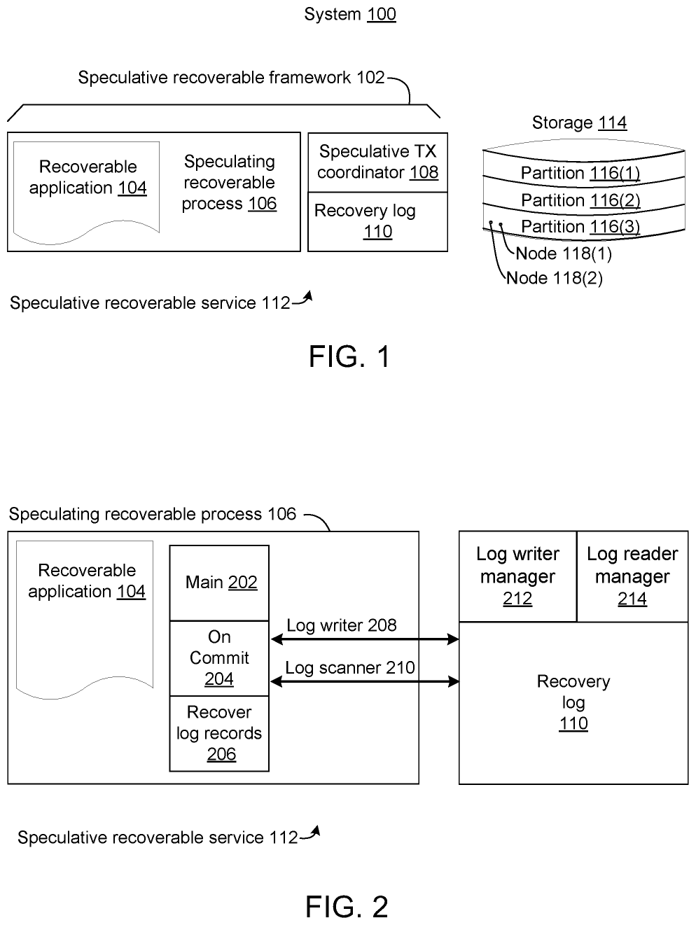

FIG. 1 shows an example system 100 that can implement the present speculative recoverable concepts. System 100 includes a speculative recoverable framework 102, a recoverable application 104, a speculating recoverable process 106, a speculative transaction coordinator 108, and a recovery log 110. The speculative recoverable framework 102 provides a speculative recoverable service 112 that facilitates aspects described above and below. For sake of brevity some instances of the speculating recoverable processes 106 may be referred to in this document as “Lattice.”

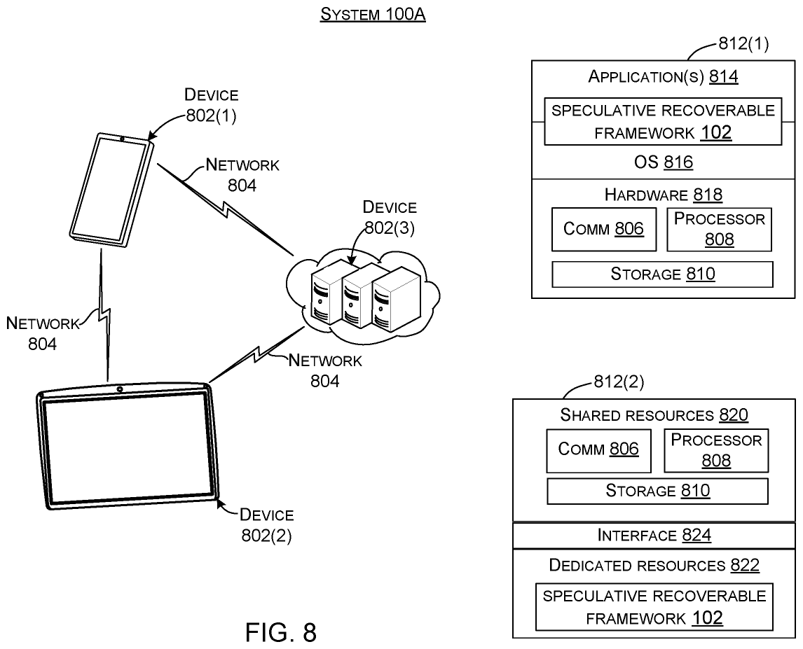

The speculative recoverable framework 102 can be integrated as part of an operating system. Alternatively, the speculative recoverable framework 102 can be a standalone component that operates in cooperation with the operating system. This aspect is described in more detail below relative to FIG. 8. System 100 can also include storage 114 that can include one or more partitions 116. Nodes 118 can be viewed as units of storage and can entail a partition 116 or a portion of the partition 116.

Recoverable applications 104 are a new, system-level, abstraction for authoring applications which can run within a recoverable process, which itself is a new execution artifact. These abstractions are system-level in the sense that they are at the same level of abstraction as traditional notions of applications (e.g., “.exe” files in the Windows brand operating system from Microsoft Corp.) and processes.

Conventional applications, at the system level, provide an entry point for code execution upon startup, and have traditionally, used the operating system provided APIs for memory allocation, storage, and communication. In recent decades, the system API for applications has expanded to include managing multi-core, GPUs, and many other features. Traditionally, once an application has started to run in the operating system, it is entirely up to the application to use the storage and communication primitives to create experiences like recoverability, migratability, and high availability, which can be a very heavy burden to place on application developers.

Over time, language specific programming frameworks have evolved to address some of these problems in the context of specific programming languages, by introducing high level programming abstractions, like persistent actors, and making hard assumptions about execution, like single-threadedness.

In contrast, recoverable applications 104 extend the traditional notion of a system level application, by introducing more system aware code entry points, used by the system for recovery, and additionally extend APIs to APIs provided by the speculative recoverable framework 102, to include the recovery log 110 used by the recoverable application 104 to persist information needed to recover the recoverable application in the event of failure or migration. Correctness in the face of failure is defined by the participating applications, and no constraints, like single-threadedness, are placed upon the execution of the recoverable application 104.

Speculating recoverable processes 106 go beyond existing recoverable processes to allow not yet durable computation results to leak outside individual nodes, realizing the multiple order of magnitude speedup described earlier, while retaining the same level of observable consistency achieved by waiting for durability within each recoverable application 104.

In particular, some of the present implementations of speculating recoverable processes 106 can identify a collection of k nodes, that participate in internal speculative execution, speculating only on log records becoming durable, such that when one node fails and recovers, the speculating recoverable process 106 will also fail and recover nodes which have taken dependencies on parts of the computation which were lost as a result of the originating failure. Speculating recoverable process 106 prevents side effects from escaping the collection, to prevent the necessity of undoing outside computation. Furthermore, speculative recoverable process 106 makes the undoing of speculation very fast by exploiting hot standbys.

The present concepts provide a technical solution that modifies two-phase commit implementations to exploit speculating recoverable processes 106. The technical solution is accomplished by modifying existing two-phase commit implementations to one that exploits speculative recoverable processes that are consistent across all implementations. Traditionally, the communications, which impact destination behavior or state, wait for log records to become locally durable before sending messages. In contrast, the technical solution causes the communications which impact destination behavior or state to include the necessary dependency information so that logged progress at the destination may incorporate this dependency in its log records. Existing APIs for delaying the leakage of side effects to clients may still be used. However, instead of waiting for local durability, the speculative recoverable service simply waits for durability of all dependent information. Note that no new application states are created by using this approach, and no further changes are needed to two-phase commit to convert it to a speculative algorithm.

Recoverable applications 104 extend the traditional notion of a system level application, by introducing more system aware code entry points, used for recovery, and additionally extend the system API to include the notion of a recovery log, used by the application to persist information needed to recover the application in the event of failure or migration.

Specifically, the application entry point can be described using the following abstract C++ class:

```
class IApplication
{
    // Main application entry point
    virtual void Main(int argc, char *argv[ ]) = 0;
};
```

Compilers are expected to produce executable applications which provide this entry point and call system API calls. Note the two arguments, which correspond to the command line parameters. Upon execution, this entry point is called once after the application is loaded into memory by the operating system. Execution continues as long as main continues to execute, and the operating system doesn't force the process to terminate.

As shown in FIG. 2, the present concepts extend this interface to main “Main” 202, on commit “OnCommit” 204, and recover log records “RecoverLogRecords” 206 as detailed below:

```
class IRecoverableApplication
{
      // New main application entry point, called on the usual main
thread
      virtual void Main(int argc, char *argv[ ],
              ApplicationLog *appendLogSessionManager,
                  LogScanner *logScanner) = 0;
      // Called by Lattice whenever a log record becomes committed
(guaranteed
      to be provided during recovery).
      // Called on a Lattice system thread, and will be called while Main
is
    // executing on the main process thread.
      virtual void OnCommit(LSN committedLSN) = 0;
      // Called prior to Main to feed log records to the application
      // when it is running as a hot standby. Note that this is called
    // synchronously on the main process thread.
      virtual void RecoverLogRecords(LogScanner *newLogRecords) =
0;
};
```

The speculative recoverable framework 102 provides three new application entry points. First, the description shows how these three entry points are called by the system. RecoverLogRecords 206 is called on the main thread (non-overlapping) zero or more times. Main 202 is called once on the main thread. OnCommit 204 is called concurrently with Main zero or more times while Main executes (not before) on a system thread.

Like traditional applications, execution continues as long as Main continues to execute, and the speculative recoverable framework 102 doesn't force the process to terminate. In order to understand how this new interface and system APIs are used, consider first how recoverable applications, like database servers, make themselves recoverable on top of existing systems APIs.

Databases employ the notion of a transaction log. As the server executes transactions, the unit of recoverable work, it logs information, like changes to data values, needed to reconstruct the correct database state in the event of a failure. Transactions are all or nothing, so every transaction ends in a commit, which if successful, is guaranteed to be recovered in the event of a failure. Similarly, failed transactions have no impact on database state, whether they are the result of failure during normal execution, or catastrophic process failure. To correctly communicate transaction commits to waiting clients, notification of commit is provided when an associated commit log record is made durable through a larger log write.

The present implementations of the application API entail giving Main two extra parameters including a system provided log writer 208 which applications use to persist log records, and a log scanner 210. The log writer 208 is described directly below. The log scanner 210 is farther described below. The log writer 208 can do two things: create sessions, and log appends.

```
class ApplicationLog :
{
      // Creates a new concurrent session for appending records to the
log
      LogSession* CreateSession( );
      // Defines a new recovery point, which once fully committed
(cannot ever be
    // rolled back), becomes active. Threadsafe.
      bool RegisterRecoveryPoint(LSN newLSNToRecoverFrom);
}
            Sessions are handles to concurrently appendable logs, and
have a single API call:
class LogSession
{
      LSN Append(ByteArray payload);
}
```

Log appends provide a simple byte array, which is appended to the recovery log 110 as a new log record in some system decided order relative to other concurrent append calls associated with other sessions. The return value is a log sequence number, which identifies the unique location in the log associated with the newly appended log record.

Keeping in mind that recovery will consist of iterating over some portion of the recovery log 110, recovery points are locations in the log from which recovery may begin. The start of the recovery log 110 is such a point from which recovery can begin, but to avoid recovering the growing recovery log 110 from the start, each time a failure occurs, applications may identify new locations from which correct recovery may occur. For instance, Aries style recovery, creates these locations in the log by recording a log record with enough information about the state of the database to ensure that at some future time, no prior log records will be needed for accurate recovery. When that moment in time occurs, a new recovery point is registered with the system, and subsequently used for recovery.

The description now returns to the OnCommit 204 entry point for a recoverable process, which was introduced above. Going back to the database server example, recall that database servers can't notify clients that transactions are committed until a commit record has been durably stored in the log. This moment occurs when the associated log write completes. The OnCommit 204 entry point is called when log records are guaranteed to be visible during recovery. Note a log sequence number (LSN) is provided, which is the highest LSN for which all prior log records and itself are now durable. In the database application example, notifications would be sent to clients once OnCommit 204 has been called with an LSN >= to the LSN associated with the commit record.

The description now turns to recovery. Recall that the first step in the lifecycle of a recoverable process is that RecoverLogRecords 206 is called some number of (non-overlapping) times. Each time it's called, log scanner 210 is provided. This log scanner 210 allows the application to inspect some portion of the recovery log 110. Many types of interfaces to access that log portion are allowable, from a simple sequential iterator interface, to a more complex interface allowing random access through an index. The entire recovery log 110 starts from the highest active registered recovery point, is collectively presented to the application through non-overlapping, sequential portions of the recovery log through the non-overlapping RecoverLogRecords 206 calls, and the final call to Main 202, which passes the last portion of the log through the provided log scanner 210.

As introduced above, recoverable processes 106 are a type of process that runs recoverable applications 104 (i.e., applications that provide the callbacks (main 202, on commit 204, and recover log records 206) in the manner described earlier. Their execution can be nested inside a traditional process through the following new system API:

```
class RecoverableProcess
{
RecoverableProcess(IRecoverableApplication& application ToRun,
      ILogWriterManager* logWriterManager,
      ILogReaderManager* logReaderManager,
      wstring instanceName,
      wstring instanceLocation,
      uint64_t logAdvance TriggerSizeMB = 0);
// Starts executing the recoverable process. Start steals the caller
thread
// which is used to call the application main.
void Start( );
}
```

From one perspective this nesting can be viewed as a “shim” that is built into and leverages existing aspects for enhanced functionality. The shim can be achieved by creating the recoverable application 104, filling in the three callbacks (202, 204, and 206), and passing recoverable application 104 into the constructor of the recoverable process 106. The speculative recoverable service 112 can also specify how recovery logs 110 are written and read by a log writer manager (ILogWriterManager) 212 and a log reader manager (ILogReaderManager) 214, the name for the process (e.g., like the names in the process list for a Windows brand OS machine), and an instance location, which specifies a location to store the recovery logs 110 which is understood by the log managers. Finally, for the purposes of cleaning up portions of the recovery log 110 which are no longer needed for recovery (behind the latest registered recovery point), the speculative recoverable service 112 can specify a size at which the current log file is truncated and a new one started, which partitions the recovery log into logAdvanceTriggerSizeMB chunks.

The speculative recoverable service 112 does not need to specify the location of the recovery log 110 as a file, or anything that specific, but can specify a string which is recognized by the log writer manager 212 and log reader manager 214. This allows recovery log 110 to be stored in a wide variety of places and modalities, like the local file system, a distributed file system, or even in cloud blob storage. Similarly, while the process name must be unique in the directory of processes, speculative recoverable service 112 does not need to specify the nature of that directory, which could be anything from a local file to a cloud key store.

When duplicate recoverable processes are run concurrently (exactly the same argument values), potentially on different machines, as long as the recovery logs 110 and process directory are accessible, one process is designated a primary, and the rest become active standbys. The standbys repeatedly poll the recovery log 110 for newly written log records written by the primary and present these log records to their associated recoverable processes through the RecoverLogRecords callback provided by the recoverable process. This allows deployers to stand up as many up-to-date replicas of the application as desired. In the case where the primary fails, the recoverable process infrastructure (e.g., the speculative recoverable framework 102) automatically picks a new primary and finishes recovery by calling the Main associated with that process, providing any log records that haven't already been consumed through RecoverLogRecords calls. In this fashion, any recoverable process may be made highly available purely as a deployment decision. Since new standbys can be created at any time, simply by starting more concurrent processes, failed replicas can be easily replaced as needed.

Recall that recoverable applications 104 recover to a point in the computation based on the log records durably appended to the recovery log 110 during normal operation. If, as a consequence of that computation, the process communicates with another process, recoverable or not, that communication is typically delayed until the log record making the contents of that communication recoverable has been made durable. This prevents other processes from taking dependencies on process states which aren't yet recoverable, significantly simplifying the interaction between processes when one of them fails.

For instance, in the two-phase commit protocol described earlier, before the prepare notification can be sent from a partition to the transaction coordinator, the prepare success log record on the partition must be made durable, so that the decision to allow the transaction has been preserved in the event of partition failure.

Unfortunately, this has the adverse effect of preventing forward progress in this part of the computation until a durable, and usually replicated for durability, write has completed, which takes far longer than the communication between the partition and the transaction coordinator (in some cases by orders of magnitude). In a highly contended workload, this could result in an orders of magnitude reduction in throughput as compared to just sending the acknowledgement message without waiting for the log write to become durable.

The description now explains the present novel speculative approach towards allowing not yet durable computation results to leak outside individual nodes. This leakage provides the multiple order of magnitude speedup compared to traditional techniques, while retaining the same level of observable consistency achieved by waiting for durability within a node.

Toward this end, the present implementations identify a collection of k nodes, that participate in internal speculative execution. The speculating relates only to log records becoming durable, such that when one node fails and recovers, the speculative recoverable process 106 will also fail and recover nodes which have taken dependencies on parts of the computation which were lost as a result of the originating failure. The speculative recoverable process 106 will still prevent side effects from escaping the collection, to prevent the necessity of undoing outside computation. Furthermore, the speculative recoverable process 106 makes the undoing of speculation very fast by exploiting hot standbys.

The description now explains how to capture dependencies with the recovery log 110. In order to understand how the speculative recoverable process 106 captures the state of the distributed computation and rolls it back to a causally consistent point in time, consider that each log record represents a local (to the node) point in the computation which the node could roll back to. The bounds of each of these computation points indicates how far each of the other nodes can be rolled back without losing any of the causes of reaching that point in the computation locally. This indication determines how far the other nodes can be rolled back without causally compromising the log record in question. Given that the other nodes' recovery points are, in turn, described by their log records, the process can therefore capture a log record's distributed dependencies with a vector of log sequence numbers representing the bounds on the causally consistent rollback of all the nodes. This vector, which is a causally consistent global recovery point in time, can be referred to as a vector timestamp.

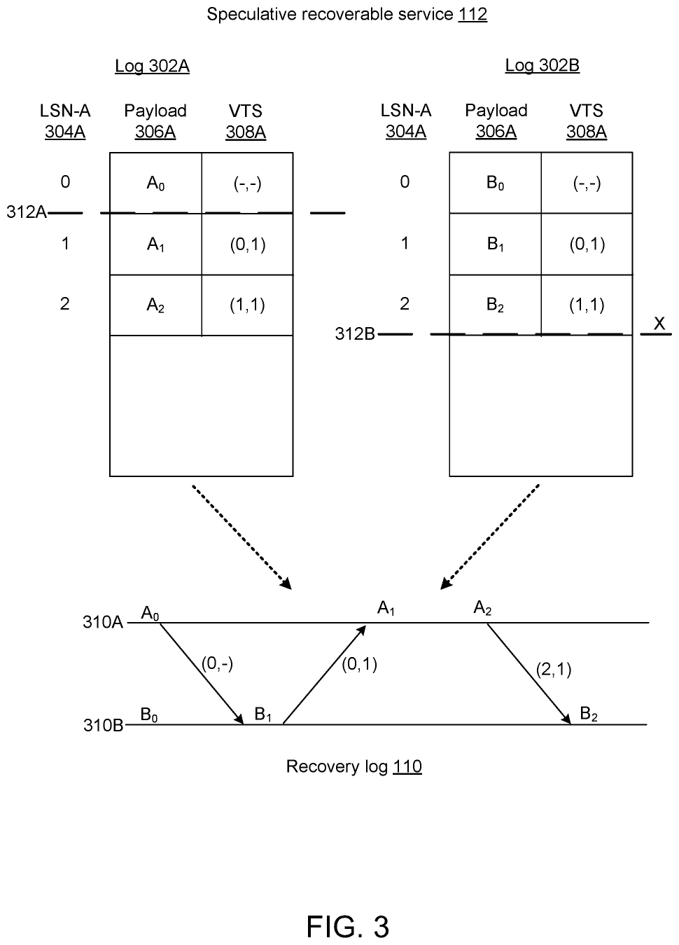

FIG. 3 shows an example recovery log 110 that relates process ‘A’ and process ‘B,’ which are reflected in log 302A and 302B, respectively. The logs include a log sequence number (LSN) column 304, a payload column 306, and a vector timestamp (VTS) column 308. Each horizontal row in the logs 302 is a log record that includes an LSN, a payload, and a vector timestamp in the respective columns.

The logs 302 populate respective communication timelines 310 of recovery log 110 relative to process A on the upper horizontal line and process B on the lower horizontal line. The corresponding vector timestamps are shown on the communication timelines 310. While not shown, the payloads can also be included with the communication timelines.

For purposes of explanation, assume that process A fails, which cascades to process B which then fails and rolls back. Dashed horizontal line 312A on log 302A shows how much of process A has been made durable at the time of the failure. Similarly, dashed horizontal line 312B on log 302B shows how much of process B has been made durable at the time of failure. The ‘X’ on the right side of log 302B indicates that LSN 2 for process B will not be recovered since it depends on LSN 2 from process A, which doesn't survive the failure.

Note that one novel aspect of FIG. 3 is that the vector clock that generates the vector timestamps is in terms of log sequence numbers. The generated vectors are passed into the log append calls and end up going into the logs 302 with the payloads.

Continuing with the explanation above, consider a scenario with a first node (e.g., node 118A) associated with a first process and a second node (e.g., node 118B) associated with a second process. The nodes send messages back and forth containing a counter in the form of a vector clock generating the vector timestamps. Each time, before sending the message, the node queue's a log record with the current counter value, but doesn't wait for the record to become durable before sending the message to the other node. The speculative recoverable service 112 records, with each log record in the recovery log 110, the log sequence number (LSN) associated with the latest log record recorded on the other node. In the event of one node failing, the speculative recoverable service 112 fails both nodes and performs an analysis during recovery to see which log records actually became durable. The speculative recoverable service 112 will recover only the log records whose dependent log records were also successfully made durable.

In particular, speculative recoverable service 112 stores, with each log record, a vector of k log sequence numbers (LSNs), where the ith LSN is associated with the log for process i, which identify the bounds in the k logs, upon which the written log depends. This information is communicated by the recoverable application when log records are appended. In particular, the Append call now becomes:

class LogSession
{
LSN Append(ByteArray payload, ByteArray timestamp, ByteArray
&outTimestamp);
}

There are now two timestamp vectors. The first, timestamp, captures the dependencies which the new log record depend on. The second, outTimestamp, can be used to capture the dependency on the log record being written in the recovery log 110. In the two process example described above, each node sends the outTimestamp from the last Append call with each message sent to the other process. The received timestamp is then used as the timestamp argument to the Append call on the other side, since it captures the dependency on the last written log record.

If a newly written log record depends on multiple incoming messages from different processes, speculative recoverable service 112 can do the max for each position across the incoming vectors to fully capture all transitive dependencies. The ‘max’ refers to how dependencies from multiple sources are combined. Each source describes its dependencies with a vector timestamp of size k. To combine them, the speculative recoverable service can, for each of the k positions in the vector, take the maximum value from the timestamps for the sources being combined. The resulting vector exactly combines the dependencies across all combined sources.

Note that speculative recoverable service 112 does not need to specify the manner in which the k LSNs are represented, which could be in a fixed size array, or even a key value dictionary, and might even employ various forms of compression. For instance, an append call can be added without the timestamp argument, and only include the timestamp in the recovery log 110 when provided by the application, to avoid redundantly representing unchanging dependencies.

Recall that speculative recoverable service 112 does not allow side effects to escape the collection of speculating nodes. This means that nodes must be notified when log records become transitively durable (not only are the log records durable, but also their dependencies). Recall the OnCommit callback for recoverable processes:

```
class IRecoverableApplication
{
      // New main application entry point, called on the usual main
thread
      virtual void Main(int argc, char *argv[ ],
              ApplicationLog *appendLogSessionManager,
                LogScanner *logScanner) = 0;
      // Called by Lattice whenever a log record becomes committed
(guaranteed
      to be provided during recovery).
      // Called on a Lattice system thread, and will be called while Main
is
    // executing on the main process thread.
      virtual void OnCommit(LSN committedLSN) = 0;
      // Called prior to Main to feed log records to the application
      // when it is running as a hot standby. Note that this is called
    // synchronously on the main process thread.
      virtual void RecoverLogRecords(LogScanner *newLogRecords) =
0;
};
```

Note that no change in the API is needed. Rather, it used to be sufficient for a log record to become durable for there to be a guarantee that it wouldn't be rolled back during recovery. Now both the log record and its dependencies must be made durable before that guarantee can be made.

In order to know when that transitive durable guarantee is met, each node must be made aware of other nodes' progress in making records durable. With such a notification mechanism, which can be either centralized or sent by communicating parties, a node will be easily able to compute whether the necessary durability requirements have been met.

For instance, in the two node example of FIG. 3, suppose the first node 118A has 10 log records, while node 118B has 11, but only 6 of node 118A's records have been made durable, while all 11 of node 118B's have been made durable. Only the first 6 records of node 118A are committed, since only 6 have been made durable, even though all of node 118B's records have been made durable. Assuming node 118A starts the computation and writes a log record before sending the first message to node 118B, only the first 6 records of node 118B are committed, since the 7ₜₕ record depends on a log record of node 118A which hasn't been made durable yet.

The speculative recoverable service 112 can detect upstream node failure. Recall that individual nodes 118 speculate on the durability of upstream nodes. When an upstream node fails, it potentially causes cascading failures in all downstream nodes. Speculative recoverable service 112 will detect such situations by having a notion of epochs, which identifies a round of recovery. All timestamp vectors include the epoch which that vector is associated with. Similarly, durability progress indicators are also tagged with the associated epoch.

When either an append is attempted from a new epoch, or a durability progress indicator is received from a new epoch, nodes fail themselves to initiate recovery. For instance, in the two node example of FIG. 3, if node 118A fails and recovers, the timestamp associated with the first message it sends to node 118B will contain a new epochID, so node 118B will fail itself and initiate recovery.

Speculative recoverable service 112 can recover a failed node. Continuing the example of FIG. 3, since node 118A recovered to a point in the computation just after the 6^{th} logged message, node 118B must scrub all of its log records, as the first step of recovery, beyond the 6^{th}, since they depend on speculation which was never made durable. Node 118B is able to do this by discovering, either from node 118A, or from a centralized source, that the latest epoch is one epoch ahead of the last log entry, and that the new epoch is defined by node 118A recovering to its 6^{th} log record. Stated another way, the information could either be disseminated by the source speculative recoverable processes sending messages, or by a separate standalone service which communicates with each of the k speculative recoverable processes. Node 118B can then eliminate all log records with dependencies on node 118A higher than 6 and recover only the log records which depend on durable log records from node 118A.

Note that if node 118B had multiple inputs and multiple failures, multiple epochs may occur before and during recovery. Therefore, during recovery, the speculative recoverable service 112 will scrub the failed speculated log records associated with both failed epochs.

From the examples described above, it should be clear that, in contrast to most distributed systems designs, speculation inherently causes failure to spread, since other nodes are taking dependencies on work which may be rolled back. In order to significantly mitigate what initially looks to be a fatal design flaw, the present concepts modify the use of the active standbys described earlier. In particular, the present concepts only allow active standbys to consume log records which are fully committed, dramatically reducing the recovery time of a failed node. Note that active secondaries may be notified about log records becoming fully committed in a variety of ways. For example, the active secondaries could be informed using the same mechanism as the primary, or the primary could add log records which indicate when other records become fully committed.

The description now explains how the present concepts modify two-phase commit techniques to exploit speculating recoverable processes. These concepts provide a technical solution that reduces latency associated with waiting for operations to be committed before proceeding. As mentioned above, applications, like distributed databases employ a two-phase commit protocol for supporting atomic transactions across database partitions, inherently suffer from low throughput. For example, participants wait for durable log writes in the first phase before initiating the second phase to ensure recovering to a consistent state in the event of a participant failure during or after the first phase.

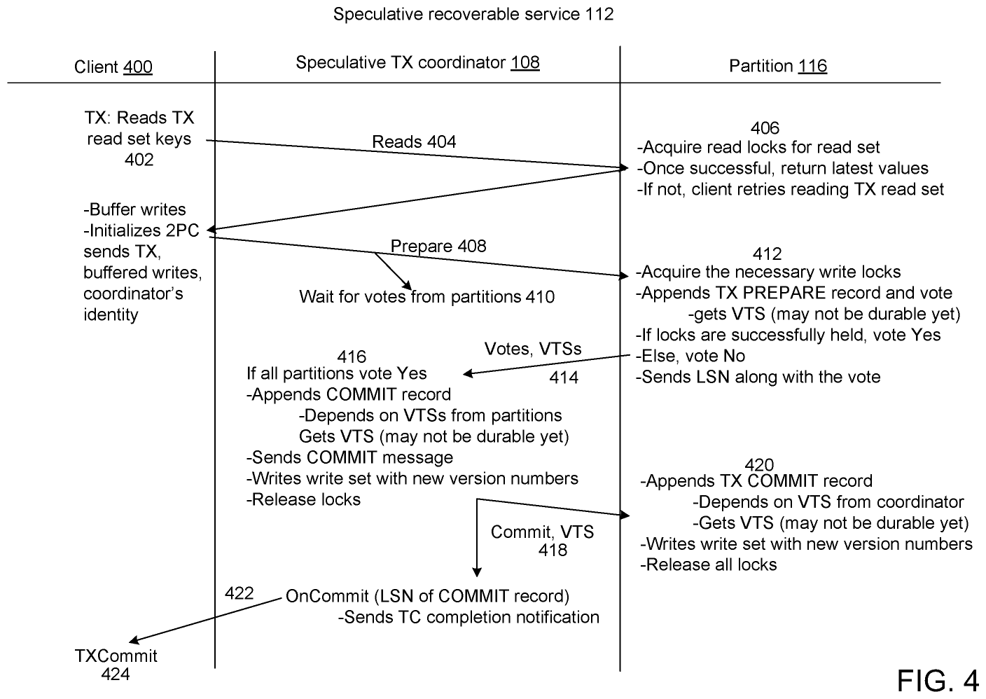

FIGS. 4-6 collectively show the speculative recoverable service 112 facilitating interactions between components to support the present concepts. The illustrated components entail a fault tolerant ‘client’ 400, speculative transaction (TX) coordinator 108, and partitions 116. The fault tolerant client handles faults in a manner consistent with the current state of the art for relational databases. The client 400 can represent portions of or activities of recoverable application 104 of FIG. 1.

This section explains modifications to the distributed database application and the basic two-phase commit protocol provided by speculative recoverable service 112. These technical changes can provide a technical solution that provides multiple orders of magnitude speedup by allowing not yet durable computation results to leak outside individual partitions 116. The speculative recoverable service 112 can achieve the increased speed while ensuring the same level of observable consistency as achieved by waiting for a durable write in the critical path. The present two-phase commit protocol has the following three modifications to be designed as a speculating recoverable process.

First, the vector timestamps from calling Append on records are communicated to other participants (e.g., in this example, other storage partitions 116). For example, storage partitions 116 send the outTimestamp they receive on a PREPARE record's Append call alongside their VOTES and the speculative transaction coordinator 108 sends the outTimestamp it receives on a COMMIT or ABORT record's Append call to the participants alongside the COMMIT or ABORT messages. Communicating these vector timestamps are crucial to take dependencies on log records becoming transitively durable and ensuring consistent recovery. Applying the present concepts does not increase the number of communication exchanges between the participants. The speculative recoverable service 112 simply passes around additional dependency information in the form of these vector timestamps across the participants.

Next, since the speculative transaction coordinator 108 notifies the client 400 of the transaction status only after the speculative transaction coordinator's COMMIT record and the participants' PREPARE records are transitively durable, the speculative transaction coordinator relies on the OnCommit entry point. This is in contrast to assuming that all incoming information was durably logged before it was sent, and waiting for local log durability. This change in behavior is encapsulated in the behavior of the speculative recoverable service 112, which chooses to call OnCommit at a different time than traditional solutions. Speculative transaction coordinator 108 therefore continues to perform client notifications in the OnCommit callback. Note that even though the final notification is delayed until the associated OnCommit callback, the speculative recoverable service 112 may continue to advance its state under the assumption that all necessary log writes will eventually be successful. There are now no log writes in the critical path of advancing the two-phase protocol state and associated database systems.

Finally, in the event of failures, the partitions 116 call RecoverLogRecords (206, FIG. 2) to replay the durably committed transactions until the time of the failure. Further, the storage partitions 116 also failover to their active standbys to recover to a globally consistent state. Periodically, the application can register checkpoints using the RegisterRecoveryPoint call to avoid replaying all the log records prior to this registered checkpoint. Note that this is all necessary, whether speculation is being performed or not, and no changes are needed to any of this.

The above-described aspects are now explained relative to FIG. 4, which illustrates the commit path of the two-phase commit protocol provided by speculative recoverable service 112. In this interaction, client 400 begins the transaction at 402. The client first fetches the data for the read set of the transaction (e.g., reads 404) from the participating partitions 116 and computes and buffers the write set of the transaction, exactly like in the basic two-phase commit protocol. Similarly, on receiving read requests, partitions 116 acquire read locks at and return the latest committed values for the requested keys to the client at 406. The client 400 then chooses an instance of the speculative transaction coordinator 108 for this transaction and initiates the first phase of the protocol by sending a PREPARE message 408 to all participants. Along with the PREPARE message, the client sends the transaction, buffered writes, and the speculative transaction coordinator's identity to all participants. The speculative transaction coordinator 108 awaits the votes at 410.

In the first phase, on receiving the PREPARE message, the partitions 116 prepare for the transaction by acquiring the necessary write locks required to commit the transaction at 412. If the partitions 116 can successfully acquire the write locks, then they vote YES and otherwise vote NO. Once the decision has been made, partitions 116 append a transaction PREPARE record and receive a vector timestamp (VTS). Finally, the partitions send their votes and their append VTSs at 414 to the speculative transaction coordinator 108. The speculative transaction coordinator 108 waits to receive votes and VTSs from all the participants during the first phase. Once the speculative transaction coordinator 108 receives all the votes it initializes the second phase of the protocol as supported by the speculative recoverable service 112.

In the second phase, at 416, the speculative transaction coordinator 108 decides to commit the transaction if it receives YES votes from all the participants. To commit the transaction, first the speculative transaction coordinator 108 appends a COMMIT record that depends on the participants' PREPARE records. To generate the correct dependency across all participating partitions, the speculative recoverable service 112 generates a new VTS which is the max for each element of the incoming VTSs from the partitions 116. The speculative transaction coordinator 108 also gets a VTS from the Append of the commit record. Then, the speculative transaction coordinator 108 sends a COMMIT message and the commit record's VTS to all the participating partitions 116 as indicated at 418. The addition of the VTS with the commit message is novel over existing technologies. This configuration provides a technical solution that includes more information to the partitions relating to the process interactions than was traditionally available.

In response to the COMMIT message, at 420, the partitions 116 write values with newer version numbers for the updated keys and log a COMMIT record that depends on the speculative transaction coordinator's COMMIT record's VTS. Once successful, the partitions 116 release all the acquired write locks. Similar to the traditional two-phase commit protocol, the lock states are also logged as part of the PREPARE or COMMIT records at the database partitions. Identical to the non-speculative case, the speculative transaction coordinator 108 implements the notification to the client 400 using the OnCommit callback, to ensure that the transaction's successful commit is notified to the client after all the necessary log record appends are transitively durable as indicated at 422. The TX commit is received by the client at 424 to finish the process.

The speculative recoverable service 112 significantly decreases latency because the service is tracking dependencies between operations. The logs of these operations can be written out asynchronously to storage partitions 116 and therefore execution can be speculative so a log of executions can get very far ahead of the operations it depends on from other logs and eventually those other logs will likely become persistent at which point the speculation will be known to become permanent/persistent. The discussion below explains how the speculative recoverable service 112 handles instances where any of the logs fail (e.g., the speculative operations do not subsequently occur).

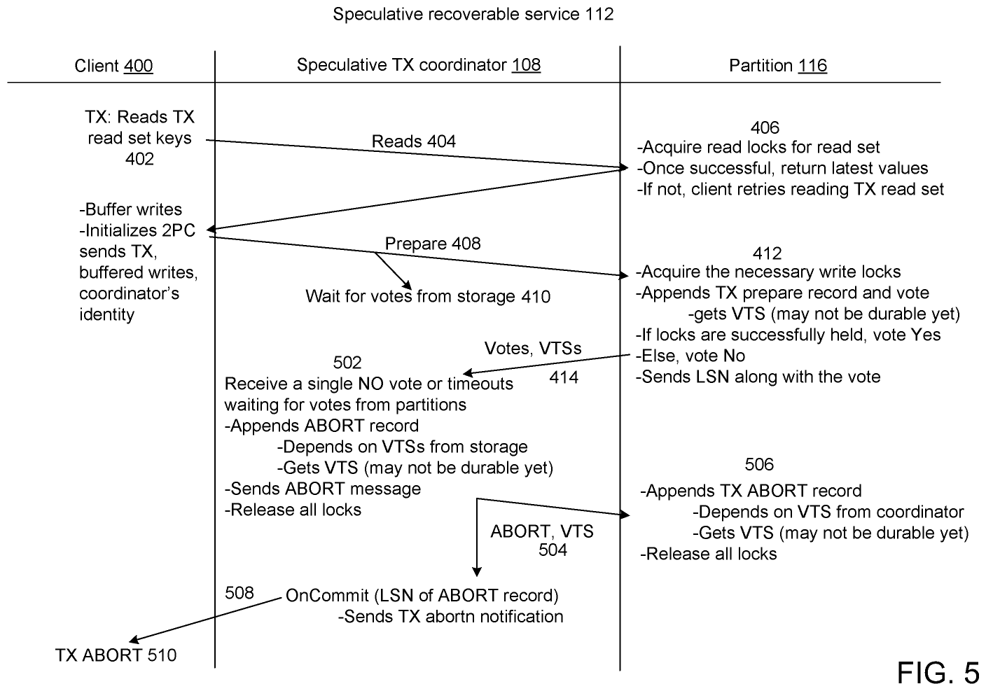

FIG. 5 is similar to FIG. 4, but relates to scenarios involving NO votes and/or failures. In the first prepare phase, the speculative transaction coordinator 108 waits to receive votes from the storage participants (e.g., the participating partitions 116) at 410 as a response to a PREPARE message 408. Note that at 502 the participants sometimes may not be able to hold the necessary write locks in the first phase and hence vote NO at 412. Further, in the event of a partition failure, the speculative transaction coordinator 108 also might not hear back (e.g., receive a response) from all the participants. To avoid wait-forever deadlocks, the speculative transaction coordinator 108 times out after waiting for votes for a certain period. In both these cases, where the speculative transaction coordinator either receives a single NO vote from the participants or times out during the first phase, the speculative transaction coordinator 108 decides to abort the transaction.

To abort a transaction, the speculative transaction coordinator 108 first appends an ABORT record and gets a VTS. The transaction coordinator sends an ABORT message and the ABORT record's VTS at 504 to all the participants and releases the locks it holds. On receiving an ABORT message, at 506, the partitions 116 also Append an ABORT record for the transaction, get a VTS, and release their locks. The speculative transaction coordinator 108 notifies the client 400 of the transaction abort during the OnCommit call associated with the transaction coordinator's append of the ABORT record as indicated at 508. The TX abort notification is received by the client at 510. By passing around the dependencies with VTSs, speculative recoverable service's two-phase commit protocol allows for consistent recovery in the event of failures while allowing speculative transaction execution.

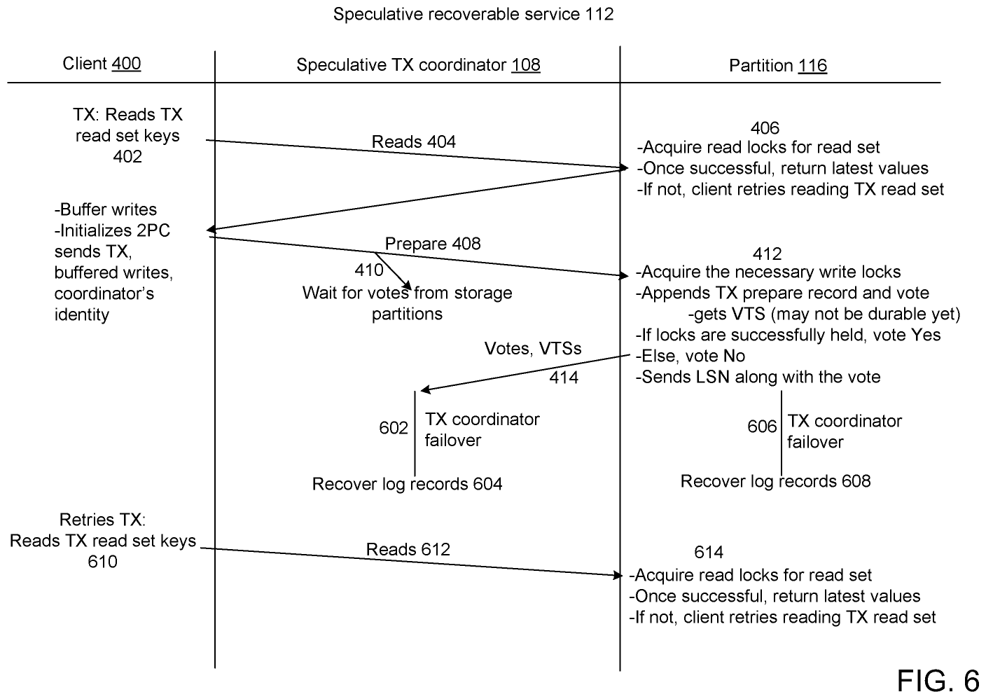

FIG. 6 is similar to FIGS. 4 and 5 but emphasizes how speculative recoverable service 112 facilitates failure handling and recovery. Designing the two-phase commit protocol as a speculative recoverable process also allows the recoverable application to recover consistently in the event of speculative transaction coordinator failure or partition failures. Hence the term ‘recoverable application.’ To describe this in detail, FIG. 6 conveys a scenario where the speculative transaction coordinator 108 fails during the first phase as indicated at 602. This speculative transaction coordinator failover causes the speculative transaction coordinator to recover log records at 604. This speculative transaction coordinator failover is recognized in the partitions 116 at 606 and causes log records to be recovered at 608.

Note that the collection of k nodes (e.g., partitions 116) that participate in the internal speculative execution includes the speculative transaction coordinator 108 and the participating storage partitions 116. Recall that when one node fails and recovers, the speculative recoverable service will also fail and recover nodes which have taken dependencies on parts of the computation which were lost as a result of the originating failure. As these k nodes may be speculating on log records becoming durable, waiting for the OnCommit for final decision notification will prevent side effects from escaping the collection.

In this scenario, the originating speculative transaction coordinator failure at 602 cascades into all the participating partitions at 604 and all of them recover to a durably consistent state. In this case, assume that only the part of the computation up to the shown coordinator failure is made fully durable (including all its dependencies). Even if the computation had actually proceeded further, with some partitions even maybe logging commit messages, if the speculative transaction coordinator only logged this much of the computation, all the others will be rolled back to this point, and execution continues as if it were operating non-speculatively and the speculative transaction coordinator and partitions had failed at this point. Since a commit or abort was never leaked to the client 400, this situation is no different, from the client's perspective, from a failure at the recovered point in the computation. Accordingly, the client 400 retries the transaction at 610, which involves reading transaction read set keys, as shown in the same manner as at the top of FIG. 6 at 402. In this latter case, the client 400 communicates reads at 612 and the partitions 116 respond at 614 in the same manner they did above at 406 to restart the transaction.

The description above explains how each speculating recoverable process records its operations in a recovery log such that each operation has a vector timestamped recovery log that describes its dependencies on operations of other speculating recoverable processes. The speculative transaction coordinator can use participant votes to decide whether to commit an operation. In the event that the speculative transaction coordinator fails the operation based upon the votes (or for some other reason) the vector timestamped recovery log identifies how far to fall back to ensure data integrity.

FIGS. 4-6 can be viewed as overall methods supported by the speculative recoverable service 112. FIGS. 4-6 also convey methods performed by individual actors, such as the speculative transaction coordinator and the partitions, among others. Additional methods are described below.

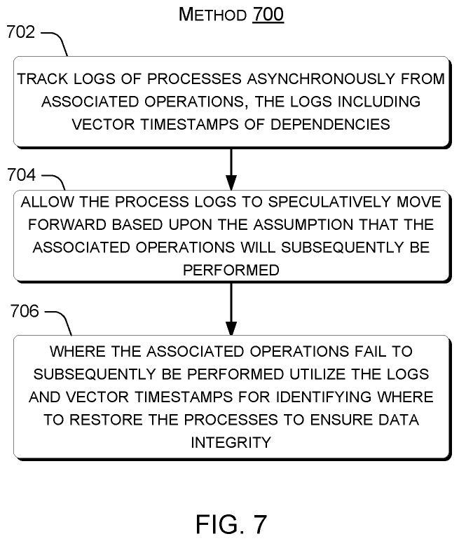

Several implementations are described in detail above. FIG. 7 shows an example speculative recoverable process operation method or technique 700.

Block 702 can track logs of processes asynchronously from associated operations, the logs including vector timestamps of dependencies.

Block 704 can allow the process logs to speculatively move forward based upon an assumption that the associated operations will subsequently be performed.

Block 706 can, in an instance where the associated operations fail to subsequently be performed, utilize the logs and vector timestamps for identifying where to restore the processes to ensure data integrity.

The order in which the disclosed methods are described is not intended to be construed as a limitation, and any number of the described acts can be combined in any order to implement the method, or an alternate method. Furthermore, the methods can be implemented in any suitable hardware, software, firmware, or combination thereof, such that a computing device can implement the method. In one case, the methods are stored on one or more computer-readable storage media as a set of instructions such that execution by a processor of a computing device causes the computing device to perform the method.

FIG. 8 shows an example system 100A that is similar to system 100 introduced relative to FIG. 1. System 100A can include computing devices 802. In the illustrated configuration, computing device 802(1) is manifest as a smartphone, computing device 802(2) is manifest as a tablet type device, and computing device 802(3) is manifest as a server type computing device, such as may be found in a (cloud) datacenter. Computing devices 802 can be coupled via one or more networks 804 that are represented by lightning bolts.

Computing devices 802 can include a communication component 806, a processor 808, storage 810, and speculative recoverable framework 102.

FIG. 8 shows two device configurations 812 that can be employed by computing devices 802. Individual devices 802 can employ either of configurations 812(1) or 812(2), or an alternate configuration. (Due to space constraints on the drawing page, one instance of each configuration is illustrated). Briefly, device configuration 812(1) represents an operating system (OS) centric configuration. Device configuration 812(2) represents a system on a chip (SOC) configuration. Device configuration 812(1) is organized into one or more applications 814, operating system 816, and hardware 818. Device configuration 812(2) is organized into shared resources 820, dedicated resources 822, and an interface 824 therebetween.

In configuration 812(1), the speculative recoverable framework 102 can be manifest as part of the processor 808. Alternatively, the speculative recoverable framework 102 can be manifest as part of the operating system 816. Further still, the speculative recoverable framework 102 can be a freestanding component that operates cooperatively with the operating system 816 and/or the processor 808 (e.g., as a freestanding service that works cooperatively with the applications and the operating system). In configuration 812(2), the speculative recoverable framework 102 can be manifest as part of the processor 808 or as a dedicated resource 822 that operates cooperatively with the processor 808.

In some configurations, each of computing devices 802 can have an instance of the speculative recoverable framework 102. However, the functionalities that can be performed by the speculative recoverable framework 102 may be the same or they may be different from one another when comparing computing devices. For instance, in some cases, each speculative recoverable framework 102 can be robust and provide all of the functionality described above and below (e.g., a device-centric implementation). In other cases, some devices can employ a less robust instance of the speculative recoverable framework 102 that relies on some functionality to be performed by another device.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the device. The storage can include any one or more of volatile or non-volatile memory, hard drives, flash storage devices, and/or optical storage devices (e.g., CDs, DVDs, etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

As mentioned above, device configuration 812(2) can be thought of as a system on a chip (SOC) type design. In such a case, functionality provided by the device can be integrated on a single SOC or multiple coupled SOCs. One or more processors 808 can be configured to coordinate with shared resources 820, such as storage 810, etc., and/or one or more dedicated resources 822, such as hardware blocks configured to perform certain specific functionality. Thus, the term “processor” as used relative to FIG. 8 can also refer to central processing units (CPUs), graphical processing units (GPUs), field programable gate arrays (FPGAs), controllers, microcontrollers, processor cores, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

Various examples are described above. Additional examples are described below. One example includes a system comprising a recoverable process that writes log records to individual storage partitions, each log record includes a vector clock timestamp vector that describes its dependencies on log records of other processes and a speculative recoverable framework that is configured to track whether the log records of the recoverable process is dependent on other log records of another recoverable process that have not been made persistent.

Another example can include any of the above and/or below examples where the speculative recoverable framework is configured to inform the recoverable process that the log record is dependent upon the other log records that have not been made persistent.

Another example can include any of the above and/or below examples where the speculative recoverable framework is configured to inform the recoverable process in a situation where the other log records are made persistent.

Another example can include any of the above and/or below examples where the log records relate to write operations and the speculative recoverable framework is configured to allow the log records to be written asynchronously to the storage partitions and the log record to progress beyond write operations from the other log records.

Another example can include any of the above and/or below examples where the speculative recoverable framework is configured to allow the log records to be written asynchronously to the storage partitions and the log record to progress beyond write operations from the other log records based upon speculation that the write operations from the other log records will be performed and made persistent.

Another example can include any of the above and/or below examples where the speculative recoverable framework is configured to track whether the write operations from the other log records are subsequently performed.

Another example can include any of the above and/or below examples where the write operations from the other log records are not subsequently performed and the speculative recoverable framework is configured to fail operations of the recoverable process that depend upon the other log records that were not subsequently performed.

Another example can include any of the above and/or below examples where the speculative recoverable framework supports a speculative transaction coordinator that is configured to examine vector timestamps from the recoverable process and the other processes.

Another example can include any of the above and/or below examples where the other processes are recoverable processes.

Another example can include any of the above and/or below examples where the system further comprises a recovery log that includes the log records and associated vector timestamps.

Another example includes a system comprising storage comprising multiple storage partitions and recoverable processes, each recoverable process configured to periodically write log records to individual storage partitions, each log record includes a vector timestamp that describes the processes' dependencies on log records of other recoverable processes.

Another example can include any of the above and/or below examples where the log records describe an operation executed by the recoverable process.

Another example can include any of the above and/or below examples where the log record is a record of a state of the recoverable process.

Another example can include any of the above and/or below examples where the recoverable processes are two-phase commit participants that are configured to communicate with a speculative transaction coordinator that is also a recoverable process.

Another example can include any of the above and/or below examples where the recoverable processes operate in cooperation with a fault tolerant client.

Another example can include any of the above and/or below examples where the fault tolerant client is performing a functionality of a recoverable application.

Another example includes a device-implemented method comprising tracking logs of processes asynchronously from associated operations, the logs including vector timestamps of dependencies allowing the process logs to speculatively move forward based upon an assumption that the associated operations will subsequently be performed and where the associated operations fail to subsequently be performed utilizing the logs and vector timestamps for identifying where to restore the processes to ensure data integrity.

Another example can include any of the above and/or below examples where the tracking comprises obtaining the logs and the vector timestamps from participating storage nodes.

Another example can include any of the above and/or below examples where the identifying comprises sending an abort message with an associated vector timestamp to the participating storage nodes.

Another example can include any of the above and/or below examples where the identifying comprises sending an on commit message when associated log records become recoverable.

### CONCLUSION

Although techniques, methods, devices, systems, etc., pertaining to speculative recoverable services concepts are described in language specific to structural features and/or methodological acts, it is to be understood that the subject matter defined in the appended claims is not necessarily limited to the specific features or acts described. Rather, the specific features and acts are disclosed as example forms of implementing the claimed methods, devices, systems, etc.

1. A system, comprising:
a recoverable process that writes log records to individual storage partitions, each log record includes a vector clock vector timestamp that describes dependencies of the log record on log records of other processes; and,
a speculative recoverable framework that is configured to track whether the log records of the recoverable process is dependent on other log records of another recoverable process that have not been made persistent.

2. The system of claim 1, wherein the speculative recoverable framework is configured to inform the recoverable process that the log record is dependent upon the other log records that have not been made persistent.

3. The system of claim 2, wherein the speculative recoverable framework is configured to inform the recoverable process in a situation where the other log records are made persistent.

4. The system of claim 3, wherein the log records relate to write operations and the speculative recoverable framework is configured to allow the log records to be written asynchronously to the storage partitions and the log record to progress beyond write operations from the other log records.

5. The system of claim 1, wherein the speculative recoverable framework is configured to allow the log records to be written asynchronously to the storage partitions and the log record to progress beyond write operations from the other log records based upon speculation that the write operations from the other log records will be performed and made persistent.

6. The system of claim 5, wherein the speculative recoverable framework is configured to track whether the write operations from the other log records are subsequently performed.

7. The system of claim 6, when the write operations from the other log records are not subsequently performed the speculative recoverable framework is configured to fail operations of the recoverable process that depend upon the other log records that were not subsequently performed.

8. The system of claim 7, wherein the speculative recoverable framework supports a speculative transaction coordinator that is configured to examine the vector timestamps from the recoverable process and the other processes.

9. The system of claim 8, wherein the other processes are recoverable processes and include the another recoverable process.

10. The system of claim 8, further comprising a recovery log that includes the log records and associated vector timestamps.

11. A system, comprising:
storage comprising multiple storage partitions; and,
recoverable processes, each recoverable process configured to periodically write log records to individual storage partitions, each log record includes a vector timestamp that describes the processes' dependencies on log records of other recoverable processes.

12. The system of claim 11, wherein the log records describe an operation executed by the recoverable process.

13. The system of claim 12, wherein the log record is a record of a state of the recoverable process.

14. The system of claim 13, where the recoverable processes are two-phase commit participants that are configured to communicate with a speculative transaction coordinator that is also a recoverable process.

15. The system of claim 13, where the recoverable processes operate in cooperation with a fault tolerant client.

16. The system of claim 15, where the fault tolerant client is performing a functionality of a recoverable application.

17. A device-implemented method, comprising:
tracking logs of processes asynchronously from associated operations, the logs including vector timestamps of dependencies;
allowing the process logs to speculatively move forward based upon an assumption that the associated operations will subsequently be performed; and,
where the associated operations fail to subsequently be performed utilizing the logs and vector timestamps for identifying where to restore the processes to ensure data integrity.

18. The method of claim 17, wherein the tracking comprises obtaining the logs and the vector timestamps from participating storage nodes.

19. The method of claim 18, wherein the identifying comprises sending an abort message with an associated vector timestamp to the participating storage nodes.

20. The method of claim 19, wherein the identifying comprises sending an on commit message when associated log records become recoverable.
